(19) United States
(12) Patent Application Publication
(10) Pub. No.: US 2022/0136569 A1
(43) Pub. Date: May 5, 2022

(54) TORQUE TRANSMISSION DEVICE FOR A MOTOR VEHICLE

(71) Applicant: VALEO EMBRAYAGES, Amiens (FR)

(72) Inventor: Herve MAUREL, Cergy Pontoise (FR)

(73) Assignee: VALEO EMBRAYAGES, Amiens (FR)

(21) Appl. No.: 17/431,058

(22) PCT Filed: Feb. 13, 2020
(86) PCT No.: PCT/EP2020/053706

§ 371 Date: Aug. 13, 2021

(30) Foreign Application Priority Data
Feb. 15, 2019 (FR) FR1901569

(51) Int. Cl. F16D 25/06; F16D 48/06

(52) U.S. Cl. CPC F16D 25/06; F16D 48/06; F16D 2500/50661; F16D 2500/1064; F16D 2500/10412; F16D 2500/70426; F16D 2500/1026

(57) ABSTRACT

A torque transmission device for a motor vehicle includes at least one motor, a first output shaft rotationally coupled to an output element of a first clutch and to an output element of a second clutch, the first output shaft to drive a first wheel of the vehicle, a second output shaft rotationally coupled to an output element of a third clutch and to an output element of a fourth clutch, the second output shaft to drive a second wheel of the vehicle, opposite the first wheel, a torque transfer mechanism to transmit the torque from the motor to an input element of the first clutch and to an input element of the fourth clutch with a first gear ratio, and to transmit the torque from the motor to an input element of the second clutch and to an input element of the third clutch with a second gear ratio.

### TECHNICAL FIELD OF THE INVENTION

The invention relates to a torque transmission device for an electric or hybrid vehicle, particularly for an electric or hybrid motor vehicle.

### PRIOR ART

Motor vehicles may notably belong to one of the following categories:
vehicles propelled by an internal combustion engine,
vehicles known as hybrid vehicles,
vehicles known as electric vehicles.

Vehicles that are propelled by an internal combustion engine conventionally comprise a gearbox and a mechanical or hydraulic transmission system. The role of the gearbox is to adapt the speed and the torque transmitted to the wheels according to the requirements of the user, the speed and the torque of the combustion engine.

Vehicles known as hybrid vehicles generally use an internal combustion engine and an electric motor. Vehicles known as electric vehicles are propelled only using electric motors. The invention applies more particularly to hybrid vehicles and to electric vehicles.

To adapt the speed and the torque, the use of electric motors generally requires a transmission including a complex set of gears and a differential mechanism to make it possible to achieve the desired speed and torque output levels at each wheel.

In a corner, the wheel situated on the inside of the bend has a shorter distance to cover and therefore does not rotate as quickly as the wheel situated on the outside of the bend. Thanks to the differential, drive is maintained while at the same time allowing the difference in speed between the wheels. It is therefore ensures better roadholding and enables tire wear to be limited.

The use of a differential has the disadvantage of transferring the same torque, in the same direction, to each wheel. Now, in numerous usage scenarios, it is rather more desirable to apply a greater torque to the shaft offering the greatest resistance, namely the wheel that has the best grip. With the use of a conventional differential, when one of the wheels is resting on a slippery surface (black ice for example), it has a tendency to spin, thus limiting the movement of the vehicle.

In order to alleviate such a disadvantage, it is known practice to employ a technique known as torque vectoring which offers the possibility of varying the torque transmitted to each wheel in order thus to improve the roadholding. For example, it is known practice to use a limited slip or self-locking electronic differential (an electronic limited slip differential eLSD) which ensures that each wheel receives sufficient torque through use of an electronic control unit. A system of the eLSD type monitors the signals originating from various wheel sensors and, in the event of wheelspin, transfers more torque to the wheel that has the better grip on the ground.

The use of such a differential system does, however, occupy a great deal of space. In order to address this problem of space, document U.S. Pat. No. 9,657,826 proposes a torque transmission device for a motor vehicle comprising an electric motor coupled to an input shaft of a first clutch mechanism via a first epicyclic gearset, and coupled to an input shaft of a second clutch mechanism via a second epicyclic gearset. The outputs of the first and second clutch mechanisms are coupled respectively to a first wheel and to a second wheel of the vehicle. The first and second clutch mechanisms are controlled in such a way as to vary the slipping of the clutches according to the torque that is to be transmitted to the wheels. The controlling of the clutches thus provides the function of vectoring the torque between the wheels.

However, the gearing of such a structure does not allow variation in the speed reduction ratio through the epicyclic gearsets, and this limits the dynamic performance of the vehicle and in particular the ability of the vehicle to rapidly reach a high speed. The invention seeks to overcome this disadvantage while at the same time avoiding breaks in torque or variations in acceleration that are perceivable to the user, in order to guarantee user comfort. The invention also seeks to limit the size of the motor used and to reduce the energy consumption of the vehicle and the space occupied by the torque transmission device.

### DISCLOSURE OF THE INVENTION

To that end, the invention relates to a torque transmission device for a vehicle comprising at least one motor, the torque transmission device comprising:
a first output shaft rotationally coupled to an output element of a first clutch and to an output element of a second clutch, the first output shaft being intended to drive a first wheel of the vehicle,
a second output shaft rotationally coupled to an output element of a third clutch and to an output element of a fourth clutch, the second output shaft being intended to drive a second wheel of the vehicle, opposite the first wheel,
a torque transfer mechanism designed to transmit the torque from said at least one motor to an input element of the first clutch and to an input element of the fourth clutch with a first gear ratio, and to transmit the torque from the motor to an input element of the second clutch and to an input element of the third clutch with a second gear ratio.

The use of at least two gear ratios makes it possible to reconcile high starting torque and maximum speed and consequently to reduce the time necessary for the vehicle to reach a high speed.

The use of at least one clutch per gear ratio and per output shaft may make it possible to control the torque supplied to each wheel and for each gear ratio, through the slipping of the clutches. The use of the clutches also makes it possible to ensure user comfort by avoiding sudden changes in gear ratio, together with perceptible changes in acceleration.

Such a structure also offers a good compromise between the increase in the complexity of the device and the improvement in dynamic performance of the vehicle, the reduction in the consumption of the vehicle and the reduction in the size of the electric traction motor and the reduction in the amount of space occupied by the device.

The vehicle may be a two-wheel drive or a four-wheel drive vehicle. The torque transmission device may operate with one or two electric motors for example. In the case of the use of two electric motors, each electric motor could for example be coupled to two wheels of the vehicle, via the clutches and the corresponding torque transfer mechanism.

The number of gear ratios may also be greater than two, for example equal to three. In that case, one clutch is associated with each wheel and with each gear ratio. In the case of three gear ratios, the number of clutches is thus equal to six.

According to one embodiment, the clutches are multidisk clutches.

The first output shaft is intended to drive the first wheel of the vehicle and not the second wheel of the vehicle.

The second output shaft is intended to drive the second wheel of the vehicle and not the first wheel of the vehicle.

The device may comprise control means for controlling the slip of the first clutch and of the fourth clutch and/or of the second clutch and of the third clutch, said control means being able to control the torque split between the first and second wheels of the vehicle, through slippage of the corresponding clutches.

The control means are able to perform the torque vectoring function in order to improve the roadholding or traction of the vehicle and its ability to negotiate obstacles. Thus, the clutches are used both for changing the gear ratio and for performing the functions of a differential and of a torque vectoring device.

The first clutch and the second clutch may be concentric with the first output shaft, the third clutch and the fourth clutch being concentric with the second output shaft, the clutches being offset axially relative to one another. The axial direction is given here by the output shafts of the transmission device.

Such a structure makes it possible to limit the radial size of the device.

Each clutch may be operated via a source of hydraulic pressure and hydraulic directional control valves controlled by a control unit.

Each clutch may be actuated by a hydraulic receiver (or piston). Each rotary hydraulic receiver may be equipped with a compensation chamber the purpose of which is to compensate for the hydraulic pressure generated by the centrifugal force on the fluid. Thus, the relationship between the force of actuation of the hydraulic receiver and the operating pressure is no longer modified by the rotational speed of the hydraulic receiver. Through its axial displacement, the hydraulic receiver is able on the one hand to close and to open the clutches (clutch engagement/disengagement) and may also regulate the slip at the friction surfaces of the clutch.

The input element of each clutch may be rotationally driven by a gear wheel concentric with the clutch and driven by a pinion the axis of which is parallel to the gear wheel. This makes it possible to limit the axial size of the device.

The axes of said pinions may be concentric.

According to one embodiment, all the pinions meshing with the gear wheels associated with the input elements of the clutches are coupled with the one same shaft.

The transmission mechanism may comprise fixed and parallel shafts coupled by gear wheels arranged in a cascading manner.

The second clutch and the third clutch may have a common input element, rotationally driven by a gear wheel common to the second clutch and to the third clutch.

Such a feature makes it possible to limit the space occupied by, and the number of elements of, the device.

The first clutch and the fourth clutch may each comprise a respective input element driven by a respective gear wheel.

The gear wheels associated with the first clutch and with the fourth clutch and/or the gear wheels associated with the second clutch and with the third clutch may have opposite helix angles.

The axial forces generated by the two gear wheels with opposing helix angles may thus compensate for one another.

The device may comprise a device for locking the first and second wheels, so that the vehicle can be immobilized.

Each clutch may be of the normally open type.

A clutch is said to be normally open if it is in the disengaged position when not actuated. Conversely, a clutch is said to be normally closed if it is in the engaged position when not actuated.

A wheel locking device may be situated between a fixed casing and each output shaft.

Each locking device thus allows the locking of the wheel associated with the corresponding output shaft.

Each wheel locking device may comprise a gear wheel rotationally coupled to the corresponding output shaft, each gear wheel being associated with a locking lever that is controlled and able to move between a locking position in which it engages in the toothset of the corresponding gear wheel so as to prevent the corresponding output shaft from rotating, and a released position in which it is disengaged from the toothset of the gear wheel so as to allow the output shaft to rotate.

The first clutch and the fourth clutch may be of the normally closed type, the second clutch and the third clutch being of the normally open type, or vice versa.

The wheel locking device may therefore be situated between a fixed casing and a shaft of the torque transfer mechanism situated between the motor and the clutches.

Each clutch may be a wet clutch. Each clutch may be a multidisk clutch. The friction linings of each clutch may be made of paper, of metal and/or of carbon.

As a variant, each clutch may be of the normally closed type. In that case, when the clutches are not actuated, namely when they are in the engaged position, the output shafts are locked by the clutches and the torque transfer mechanism with two gear ratios.

The device may comprise speed sensors at the output shafts, and calculation means able to determine the torque transmitted to each wheel, for example as a function of the speed of the output shaft and/or as a function of the pressure in the clutches.

Each output shaft may comprise a first end coupled to the corresponding wheel and a second end opposite to the first end.

Each output shaft may comprise at least one first cylindrical part having a first diameter, situated on the first-end side, and a second cylindrical part having a second diameter, situated on the second-end side, the first diameter being greater than the second diameter. The clutch associated with the lowest gear ratio is situated on the first-end side, the clutch associated with the highest gear ratio being situated on the second-end side.

The first gear ratio is the ratio between the speed of the input elements of the first clutch and/or of the fourth clutch to the speed of the motor. The second gear ratio is the ratio between the speed of the input elements of the second clutch and/or of the third clutch to the speed of the motor.

A low gear ratio generates a high torque at the output shaft, whereas a relatively higher gear ratio generates a relatively lower torque at the output shaft.

The gear ratio of the input elements of the first clutch and of the fourth clutch is lower than the gear ratio of the input elements of the second clutch and of the third clutch.

According to one embodiment, the output elements of the second clutch and of the third clutch are positioned axially between the output elements of the first clutch and of the fourth clutch. In other words, for each output shaft, the clutch associated with the lowest gear ratio is positioned closest to the wheel with respect to the other clutch or other clutches associated with this output shaft.

The above-mentioned feature thus makes it possible to limit the axial distance between the wheel and the clutch that transmits the highest torques, so as to reduce the twisting or bending of the shaft. This is especially important since the shaft may be stepped and have a diameter that decreases in the direction away from the wheel.

According to another embodiment, the shaft of the transmission mechanism bearing the drive pinions is formed of at least two portions.

The clutches may each comprise a respective input element driven by a respective gear wheel.

According to one embodiment, certain input elements and their respective gear wheel may be manufactured as a single piece.

According to one embodiment, the first clutch and the second clutch comprise a common output element. Likewise, the third clutch and the fourth clutch comprise a common output element.

The output elements each comprise a body of cylindrical or tubular cross section.

These bodies preferably extend axially in the continuation of the output shafts.

The transmission device comprises at least one fluid supply duct.

Preferably, a space axially separates the common output element of the first and second clutches and the common output element of the third and fourth clutches. Advantageously, part of said at least one duct is positioned in this space.

Preferably, at least one of the output elements of the clutches comprises a tubular body and part of said at least one duct is arranged inside the tubular body. The axis of the tubular body is preferably coaxial with the axes of the output shafts.

If appropriate, the body of this output element also comprises a drilling that allows the inside of the tubular body and the outside of the tubular body to communicate, at the level of an actuating chamber of a clutch.

If appropriate, said at least one duct communicates with the drilling or enters this drilling. According to another embodiment which has not been depicted, each clutch comprises its own output element, the output element of the first clutch being coupled with the output element of the second clutch, and the output element of the third clutch being coupled with the output element of the fourth clutch, a space axially separating the output element of the second clutch and the output element of the third clutch.

The invention also relates to a torque transmission module for a torque transmission device as described hereinabove, the module comprising:
a first output shaft rotationally coupled to an output element of a first clutch and to an output element of a second clutch, the first output shaft being intended to drive a first wheel of the vehicle,
a second output shaft rotationally coupled to an output element of a third clutch and to an output element of a fourth clutch, the second output shaft being intended to drive a second wheel of the vehicle, opposite the first wheel,
an input element of the first clutch and an input element of the fourth clutch which are configured to transmit a torque in a first operating range,
an input element of the second clutch and an input element of the third clutch which are configured to transmit a torque in a second operating range, the second operating range corresponding to conditions at higher speeds.

The invention also relates to a torque transmission system for a vehicle comprising an electric motor and a torque transmission device as described hereinabove, the transmission mechanism being designed to be driven by the motor.

The invention also relates to a method for controlling a torque transmission device as described hereinabove, wherein the torque transmission device comprises a first output shaft rotationally coupled to an output element of a first clutch and to an output element of a second clutch, the first output shaft being intended to drive a first wheel of the vehicle, a second output shaft rotationally coupled to an output element of a third clutch and to an output element of a fourth clutch, the second output shaft being intended to drive a second wheel of the vehicle, opposite to the first wheel, the method comprising the following steps:
engaging the first and fourth clutches and disengaging the second and third clutches when, of the first output shaft and the second output shaft, at least one is rotating at a first operating speed,
engaging the second and third clutches and disengaging the first and fourth clutches when, of the first output shaft and the second output shaft, at least one is rotating at a second operating speed,

The control method may further comprise the following step:
controlling the slipping of the first or of the fourth clutch when the first and fourth clutches are engaged in order to vary the speed and the torque between the first output shaft and the second output shaft, or
controlling the slipping of the second or of the third clutch when the second and third clutches are engaged in order to vary the speed and the torque between the first output shaft and the second output shaft.

The control of the slipping may be initiated by a control unit when it receives data indicative of a change in direction of the vehicle. The control unit may execute the steps of operating (engaging/disengaging) the clutches and controlling the slip at the clutches.

The invention also relates to a torque transmission device for a vehicle comprising at least one motor, the torque transmission device comprising:
a first output shaft rotationally coupled to an output element of a clutch, the first output shaft being intended to drive a first wheel of the vehicle,
a second output shaft rotationally coupled to an output element of another clutch, the second output shaft being intended to drive a second wheel of the vehicle, opposite the first wheel,
a torque transfer mechanism designed to transmit the torque from the motor to an input element of the two clutches,

each clutch being of the normally open type and the device further comprising a device for locking the first and second wheels, each wheel locking device comprising a gear wheel rotationally coupled to the corresponding output shaft, each gear wheel being associated with a locking lever that is able to move between a locking position in which it engages in the toothset of the corresponding gear wheel so as to prevent the corresponding output shaft from rotating, and a released position in which it is disengaged from the toothset of the gear wheel so as to allow the output shaft to rotate.

This torque transmission device may further comprise at least one of the features mentioned hereinabove.

The invention also relates to a torque transmission device comprising a torque input member intended to be driven by a motor, notably an electric motor, an output member, a transmission module designed to transmit a torque between the input member and the output member, the transmission module comprising:
a transmission member capable of rotating about an axis X,
a first wet clutch comprising a first radially outer disk carrier, a first radially inner disk carrier and a first multidisk assembly with at least one friction disk rotationally coupled with the first radially outer disk carrier, and at least one other disk rotationally coupled with the first radially inner disk carrier,
a second wet clutch comprising a second radially outer disk carrier, a second radially inner disk carrier and a second multidisk assembly with at least one friction disk rotationally coupled with the second radially outer disk carrier, and at least one other disk rotationally coupled with the second radially inner disk carrier,
a transmission wheel such as a gear wheel rotationally coupled with the first radially inner disk carrier,
another transmission wheel such as a gearwheel rotationally coupled with the second radially inner disk carrier, the transmission device being configured so that, for a first gear ratio between the input member and the output member the torque passes via one of the two transmission wheels, and that for a second gear ratio between the input member and the output member the torque passes via the other of the two transmission wheels,

the transmission member comprising the first radially outer disk carrier and the second radially outer disk carrier and a tubular body rigidly connected in terms of rotation to the first radially outer disk carrier and to the second radially outer disk carrier, the device further comprising at least one duct of which at least part extends inside the tubular body in order to supply the first and/or second clutches with fluid, the tubular body extending radially inside the first radially inner disk carrier and the second radially inner disk carrier.

This torque transmission device may further comprise at least one of the features mentioned hereinabove and/or at least one of the following features:

The first radially inner disk carrier and the second radially inner disk carrier are rotationally coupled with the input member via the two transmission wheels respectively, and the tubular body is rotationally coupled with the output member.

In a variant, the first radially inner disk carrier and the second radially inner disk carrier are rotationally coupled with the output member via the two transmission wheels respectively, and the tubular body is rotationally coupled with the input member.

The tubular body extends along the axis X.

The two transmission wheels have different diameters.

The device comprises a wheel meshing with one of the two transmission wheels and a wheel meshing with the other of the two transmission wheels, these two wheels having different diameters.

The disks of the multidisk assembly of the first clutch and the disks of the multidisk assembly of the second clutch have substantially the same diameters and are arranged around the axis X.

The first clutch has a first actuating piston and the second clutch has a second actuating piston, the first piston and the second piston being arranged axially between the multidisk assembly of the first clutch and the multidisk assembly of the second clutch.

The first piston moves axially away from the second clutch in order to compress the multidisk assembly of the first clutch, and the second piston moves axially away from the first clutch in order to compress the multidisk assembly of the second clutch.

The first clutch and the second clutch are arranged around the axis X.

The first and second clutches are arranged symmetrically with respect to a plane extending radially between the first piston and the second piston.

The first radially inner disk carrier is mounted with the ability to rotate on the tubular body via a first bearing, notably a rolling bearing.

The second radially inner disk carrier is mounted with the ability to rotate on the tubular body via a second bearing, notably a rolling bearing.

The transmission member comprises a connecting portion which extends radially and which connects the first radially outer disk carrier and the second radially outer disk carrier to the tubular body.

The transmission member has an axis of symmetry passing through the connecting portion.

A first actuating chamber is formed between the first piston and the connecting portion.

A second actuating chamber is formed between the second piston and the connecting portion.

Said at least one duct communicates with the first actuating chamber and/or the second actuating chamber.

The layout of the transmission module is thus very well suited, in a simple way, to fluid actuation.

The output member is able to drive a vehicle differential or a vehicle wheel.

### BRIEF DESCRIPTION OF THE FIGURES

FIG. 1 is a perspective view of a torque transmission device according to one embodiment of the invention,

FIG. 2 is a side view of the device,

FIG. 3 is a view in section of the device,

FIG. 4 is a schematic view in section of the device according to another embodiment.

### DETAILED DESCRIPTION OF THE INVENTION

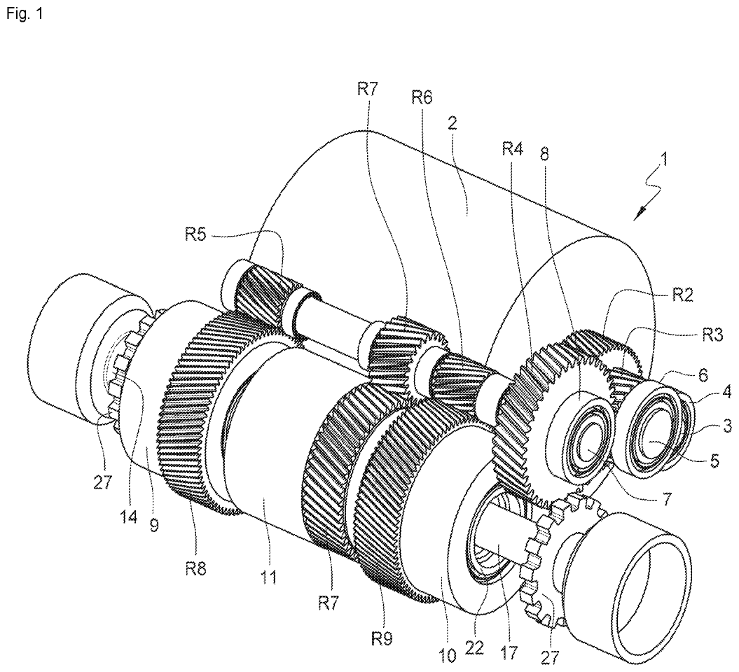

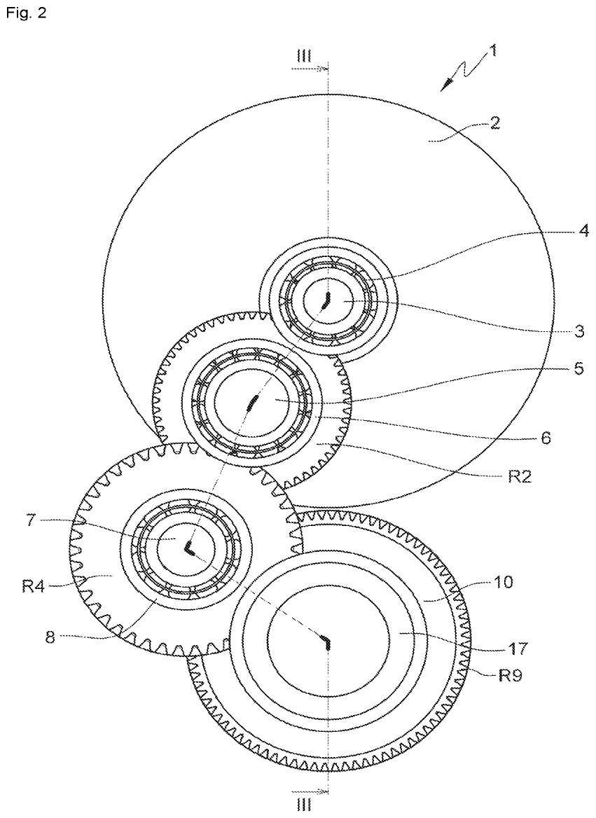

FIGS. 1 to 3 depict a torque transmission system 1 for a hybrid or fully electric motor vehicle. The transmission system comprises a motor 2 and a transmission device 1 designed to transmit torque between the motor and the wheels of the vehicle.

The transmission device comprises a first output shaft 14 intended to drive a first wheel of the vehicle, and a second output shaft 17 intended to drive a second wheel of the vehicle, opposite to the first wheel.

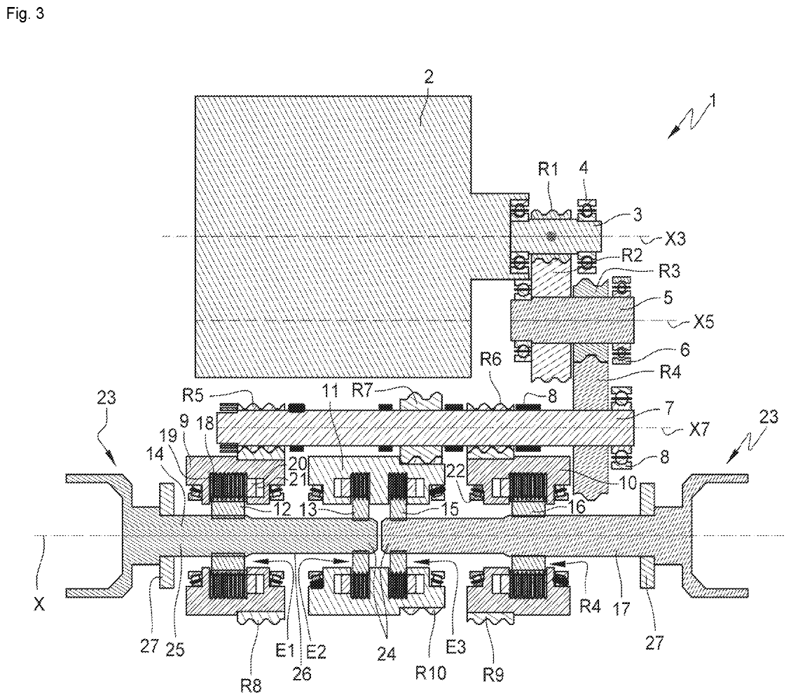

The electric motor 2 comprises a stator, and a rotor coupled to a rotary shaft 3 of the motor 2. The rotary shaft 3 of the motor 2, of axis X3, is guided in rotation via ball bearings 4. The shaft 3 drives a transmission mechanism comprising a gear wheel R1 borne by the shaft 3. The transmission mechanism further comprises a first rotary shaft 5, of axis X5, guided in rotation by ball bearings 6. The first rotary shaft 5 bears a gear wheel R2 and a gear wheel R3. The gear wheel R2 meshes with the gear wheel R1. The diameter of the gear wheel R3 is less than the diameter of the gear wheel R2. The gear wheel R3 is situated to the right of the gear wheel R2 in FIG. 3, namely on the opposite side to the electric motor 2.

The transmission mechanism further comprises a second rotary shaft 7, of axis X7, guided in rotation by ball and/or roller bearings 8. The bearings 4, 6, 8 are supported by a fixed casing, not depicted.

The second shaft 7 bears a gear wheel R4 meshing with the gearwheel R3, two pinions R5 and R6 associated with a first gear ratio and a pinion R7 associated with a second gear ratio.

The pinions R5, R6 and R7 have teeth. The diameter of the gear wheel R4 is greater than the diameter of the gear wheel R3.

The pinion R7 is situated axially, namely along the axis of the second shaft 7, between the pinion R5, situated to the left in FIG. 3, and the pinion R6, situated to the right in that same figure. The gear wheel R4 is situated to the right of the pinion R6.

The axes X3, X5 and X7 of the shafts 3, 5, 7 are mutually parallel. The gear wheels and pinions R1 to R7 have helical teeth.

The pinion R5 and the pinion R6 mesh respectively with a ring gear or a gear wheel R8 and with a ring gear or a gear wheel R9.

The pinions R5 and R6 have opposite helix angles. Likewise, the ring gears R8 and R9 have opposite helix angles.

The ring gear R8 is borne by an annular input element 9 of a clutch E1.

The ring gear R9 is borne by an annular input element 10 of a clutch E4.

The pinion R7 meshes with a ring gear or with a gear wheel R10 borne by an annular input element 11, and common to a clutch E2 and to a clutch E3.

The toothsets of the ring gears R8, R9, R10 are helical. The ring gears are also coaxial, their axis X being parallel to the axes X3, X5 and X7. Their axis X is also coaxial with the output shafts 16, 17.

The clutches E1 and E2 respectively comprise output elements 12, 13 rotationally coupled to the output shaft 14 of axis X.

The clutches E3 and E4 respectively comprise output elements 15, 16 rotationally coupled to the output shaft 17 of axis X.

Each clutch E1 to E4 further comprises a first series of disks 18 which are rotationally coupled to the input element and a second series of disks 19 which are rotationally coupled to the output element, the disks 19 being interleaved between the disks 18. The disks 18, 19 are caused to be pressed against one another by an annular piston 20 actuated by a hydraulic fluid opening into a pressure chamber 21 of the corresponding input element 9, 10, 11, in which element the piston 20 is mounted.

The movement of each piston 20 is controlled by control means. It will be noted that, in this embodiment, the pistons 20 are able to rotate with the input elements 9, 10, 11.

The input elements 9, 10, 11 of the clutches E1 to E4 are guided in rotation by roller bearings 22.

Each output shaft 14, 17 comprises a first end 23 coupled in rotation to a wheel of the vehicle, via a constant-velocity joint such as a Cardan joint for example, and a second end 24 opposite to the first end 23.

The output shafts 14, 17 are coaxial with one another, with the input elements 9, 10, 11 and output elements 12 to 16 of the clutches E1 to E4, and with the ring gears R8, R9 and R10.

Each output shaft 14, 17 comprises a first cylindrical part 25 having a first diameter, situated on the first-end 23 side, and a second cylindrical part 26 having a second diameter, situated on the second-end 24 side, the first diameter being greater than the second diameter. Each output shaft 14, 17 is thus a stepped shaft.

The output elements 12, 16 of the clutches E1 and E4 are situated near the first end 23 of each output shaft 14, 17. The output elements 13, 15 of the clutches E2 and E3 are situated near the second end 24 of each output shaft 14, 17.

The ratio of the rotational speed of the input elements 9, 10 of each of the clutches E1 and E4 to the rotational speed of the shaft 3 of the motor 2, referred to as the first gear ratio, is, for example, comprised between 1/20 and 1/10 when the clutches E1 and E4 are in the engaged position, namely when a torque can be transmitted to the output shafts 14, 17 through said clutches E1 and E4.

The ratio of the rotational speed of the input element 11 of the clutches E2 and E3 to the rotational speed of the shaft 3 of the motor 2, referred to as the second gear ratio, is, for example, comprised between 1/10 and 1/5 when the clutches E2 and E3 are in the engaged position, namely when a torque can be transmitted to the output shafts 14, 17 through said clutches E2 and E3.

In general, the first gear ratio is lower than the second gear ratio. The clutches dedicated to the first gear ratio are closer to the wheels than the clutches dedicated to the second gear ratio.

The clutches are of the normally open type in the embodiment depicted in the figures.

Each output shaft 14, 17 is equipped with a system for locking the corresponding wheel, intended to allow the vehicle to be immobilized. Each locking system comprises a gear wheel 27 rotationally coupled to the corresponding output shaft 14, 17, each gear wheel 27 being associated with a locking lever that is controlled and able to move between a locking position in which it engages in the toothset of the corresponding gear wheel 27 so as to prevent the corresponding output shaft 14, 17 from rotating, and a released position in which it is disengaged from the toothset of the gear wheel 27 so as to allow the corresponding output shaft 14, 17 to rotate.

In operation, the clutches E1 to E4 are actuated according to the gear ratio selected. In other words, if the first gear ratio is to be used, the clutches E1 and E4 are actuated so as to move into the engaged or closed position, while the clutches E2 and E3 are not actuated, so that they are moved into the disengaged or open position. The torque is thus transmitted from the motor 2 to each of the output shafts 14, 17 notably via the clutches E1 and E4.

Each clutch is of the multidisk type and the input elements form radially outer disk carriers of the clutches, and the output elements form the radially inner disk carriers of the clutches. The radial dimension is considered with respect to the axes of the output shafts.

Conversely, if the second gear ratio is to be used, the clutches E2 and E3 are actuated so as to move into the engaged or closed position, while the clutches E1 and E4 are not actuated, so that they are moved into the disengaged or open position. The torque is thus transmitted from the motor 1 to each of the output shafts 14, 17 notably via the clutches E2 and E3.

Furthermore, the torque vectoring function may be obtained by controlling the torque is applied to each wheel and for each speed by regulating, as required, the slipping of each clutch E1 to E4 concerned. Regulation can be achieved by calculating the torque transmitted to each wheel, for example from information regarding the speed of the output shafts 14, 17 and regarding the pressure in the clutches. To do that, each output shaft 14, 17 may be equipped with a sensor, not depicted, able to detect the rotational speed thereof.

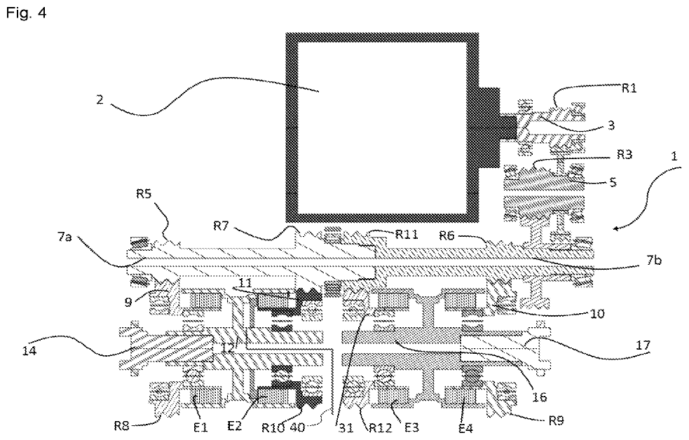

Another embodiment is illustrated in FIG. 4. This embodiment differs from the preceding one notably in terms of the features set out hereinbelow.

The shaft 3 may be formed as one piece with the gear wheel R1. Likewise, the shaft 5 can be formed as one piece with the gear wheel R3.

The second shaft of the transmission mechanism is made up of two coaxial sections 7a and 7b coupled to one another. For example, a portion of the end of the section 7a is centered in a portion of the end of the section 7b, and another portion of the end of the section 7a is engaged with splines in another portion of the end of the section 7b. One of the sections 7a is associated with the first clutch E1 and with the second clutch E2, and the other section 7b is associated with the third clutch E3 and with the fourth clutch E4.

The pinions R5, R6, R7 and R11 may also be formed as one piece with the corresponding section 7a, 7b of shaft.

The clutches each comprise a respective input element 9, 11, 31, 10 driven by a respective gear wheel. Each section 7a, 7b therefore bears, unable to rotate independently of it, two pinions which each mesh with a gear wheel.

The input elements 9, 11, 31, 10 form radially inner disk carriers of the clutches and the output elements 12 and 16 form the radially outer disk carriers of the clutches.

The first clutch E1 and the second clutch E2 share a common output element 12. Likewise, the third clutch E3 and the fourth clutch E4 share a common output element 16. The output elements 12 and 16 comprise a body of tubular cross section extending axially in the continuation of the first and second output shafts.

A space axially separates the common output element 12 of the first and second clutches and the common output element 16 of the third and fourth clutches. It is thus possible to use this space to run through it at least one duct 40 that supplies the clutches with fluid. FIG. 4 schematically indicates just one duct for supplying the second clutch E2. Of course, each clutch may be supplied with fluid in the way schematically indicated in respect of the second clutch E2.

Because the output elements 12 and 16 of the clutches have a body that is tubular, each duct 40 can pass inside the tubular body of the output element of the clutch it is to supply. This output element 12, 16 further comprises a drilling that causes the inside of the tubular body and the outside of the tubular body to communicate, at the level of an actuating chamber of the clutch that is to be supplied. The duct can therefore communicate with the drilling or enter this drilling.

Each output element 12, 16 comprises a connecting disk respectively connecting:
a portion of the output element forming the radially outer disk carrier of a clutch,
a portion of the output element forming the radially outer disk carrier of another clutch, the disk being arranged axially between these two disk carriers,
the tubular body of said output element positioned radially on the inside of these disk carriers.

The input elements of the clutches are mounted with the ability to pivot about the corresponding output elements of the clutches, notably the tubular body thereof.

So far as the first clutch and the second clutch are concerned, the first wet clutch E1 comprising a first radially outer disk carrier, a first radially inner disk carrier and a first multidisk assembly with at least one friction disk rotationally coupled with the first radially outer disk carrier, and at least one other disk rotationally coupled with the first radially inner disk carrier. The second wet clutch E2 comprising a second radially outer disk carrier, a second radially inner disk carrier and a second multidisk assembly with at least one friction disk rotationally coupled with the second radially outer disk carrier, and at least one other disk rotationally coupled with the second radially inner disk carrier.

The transmission gear wheel R8 is rotationally coupled with the first radially inner disk carrier and the transmission gear wheel R10 is rotationally coupled with the second radially inner disk carrier.

The first radially outer disk carrier and the second radially outer disk carrier as well as the tubular body connected rigidly in terms of rotation to the first radially outer disk carrier and to the second radially outer disk carrier together form a transmission member which in this instance is an output element 12. The tubular body extends along the axis X.

The first radially inner disk carrier and the second radially inner disk carrier are rotationally coupled with the torque transmission mechanism via the two wheels R8 and R10 respectively. The two wheels R8 and R10 have different diameters. The pinions R5 and R7 meshing with the gear wheels R8 and R10 also have different diameters.

The first clutch E1 has a first actuating piston and the second clutch E2 has a second actuating piston (not depicted), the first piston and the second piston being arranged axially between the multidisk assembly of the first clutch and the multidisk assembly of the second clutch. The first piston moves axially away from the second clutch in order to compress the multidisk assembly of the first clutch, and the second piston moves axially away from the first clutch in order to compress the multidisk assembly of the second clutch.

It may be seen that the first and second clutches are arranged symmetrically with respect to a plane extending radially between the first piston and the second piston.

The first radially inner disk carrier is mounted with the ability to rotate on the tubular body via a first rolling bearing. The second radially inner disk carrier is mounted with the ability to rotate on the tubular body via a second rolling bearing.

The transmission member comprises a connecting portion which extends radially and which connects the first radially outer disk carrier and the second radially outer disk carrier to the tubular body.

A first actuating chamber is formed between the first piston and the connecting portion, and a second actuating chamber is formed between the second piston and the connecting portion.

1. A torque transmission device for a vehicle comprising at least one motor, the torque transmission device comprising:
a first output shaft rotationally coupled to an output element of a first clutch and to an output element of a second clutch, the first output shaft being intended to drive a first wheel of the vehicle,
a second output shaft rotationally coupled to an output element of a third clutch and to an output element of a fourth clutch, the second output shaft being intended to drive a second wheel of the vehicle, opposite the first wheel,
a torque transfer mechanism designed to transmit the torque from the motor to an input element of the first clutch and to an input element of the fourth clutch with a first gear ratio, and to transmit the torque from said at least one motor to an input element of the second clutch and to an input element of the third clutch with a second gear ratio.

2. The device as claimed in claim 1, further comprising:
control means for controlling the slip of the first clutch and of the fourth clutch, and/or, of the second clutch and of the third clutch, said control means being able to control the torque split between the first and second wheels of the vehicle, through slippage of the corresponding clutches.

3. The device as claimed in claim 1, wherein the first clutch and the second clutch are concentric with the first output shaft, the third clutch and the fourth clutch being concentric with the second output shaft, the clutches being offset axially relative to one another.

4. The device as claimed in claim 1, wherein each clutch is operated via a source of hydraulic pressure and hydraulic directional control valves controlled by a control unit.

5. The device as claimed in claim 1, wherein each clutch is actuated by a rotary hydraulic receiver.

6. The device as claimed in claim 1, wherein the input element of each clutch is rotationally driven by a gear wheel concentric with the clutch and driven by a pinion of which the axis is parallel to the gear wheel.

7. The device as claimed in claim 6, wherein the axes of said pinions are concentric.

8. The device as claimed in claim 1, wherein the second clutch and the third clutch comprise a common input member rotationally driven by a gear wheel common to the second clutch and to the third clutch.

9. The device as claimed in claim 1, wherein the first clutch and the fourth clutch each comprise a respective input element driven by a respective gear wheel.

10. The device as claimed in claim 9, wherein the gear wheels associated with the first clutch and with the fourth clutch and/or the gear wheels associated with the second clutch and with the third clutch have opposite helix angles.

11. The device as claimed in claim 1, comprising a locking device for locking the first and second wheels, wherein each clutch is of the normally open type, each wheel locking device comprises a gear wheel rotationally coupled to the corresponding output shaft, each gear wheel being associated with a locking lever that is controlled and able to move between a locking position in which it engages in the toothset of the corresponding gear wheel so as to prevent the corresponding output shaft from rotating, and a released position in which it is disengaged from the toothset of the gear wheel so as to allow the output shaft to rotate.

12. The device as claimed in claim 1, wherein the gear ratio of the input elements of the first clutch and of the fourth clutch is lower than the gear ratio of the input elements of the second clutch and of the third clutch; and the output elements of the second clutch and of the third clutch being positioned axially between the output elements of the first clutch and of the fourth clutch.

13. The device as claimed in claim 1, wherein the transmission device comprises at least one fluid supply duct and at least one of the output elements of the clutches comprises a tubular body and said at least one duct passes inside the tubular body.

14. A torque transmission module for a torque transmission device as claimed in claim 1, the module comprising:
a first output shaft rotationally coupled to an output element of a first clutch and to an output element of a second clutch, the first output shaft being intended to drive a first wheel of the vehicle,
a second output shaft rotationally coupled to an output element of a third clutch and to an output element of a fourth clutch, the second output shaft being intended to drive a second wheel of the vehicle, opposite the first wheel,
an input element of the first clutch and an input element of the fourth clutch which are configured to transmit a torque in a first operating range,
an input element of the second clutch and an input element of the third clutch which are configured to transmit a torque in a second operating range, the second operating range corresponding to conditions at higher speeds.

15. A torque transmission system for a vehicle comprising an electric motor and a torque transmission device as claimed in claim 1, the transmission mechanism being designed to be driven by the motor.

16. The device as claimed in claim 2, wherein the first clutch and the second clutch are concentric with the first output shaft, the third clutch and the fourth clutch being concentric with the second output shaft, the clutches being offset axially relative to one another.

17. The device as claimed in claim 2, wherein each clutch is operated via a source of hydraulic pressure and hydraulic directional control valves controlled by a control unit.

18. The device as claimed in claim 2, wherein each clutch is actuated by a rotary hydraulic receiver.

19. The device as claimed in claim 2, wherein the input element of each clutch is rotationally driven by a gear wheel concentric with the clutch and driven by a pinion of which the axis is parallel to the gear wheel.

20. The device as claimed in claim 2, wherein the second clutch and the third clutch comprise a common input member rotationally driven by a gear wheel common to the second clutch and to the third clutch.
